(19) United States
(12) Patent Application Publication
(10) Pub. No.: US 2007/0217727 A1
(43) Pub. Date: Sep. 20, 2007

(54) Wheel hub and bearing arrangement, and a method for mounting such an arrangement

(75) Inventors: Uno Axelsson, Katrineholm (SE); Cengiz R. Shevket, Novi, MI (US)

Correspondence Address: BUCHANAN, INGERSOLL & ROONEY PC, POST OFFICE BOX 1404, ALEXANDRIA, VA, 22313-1404, US

(73) Assignee: Aktiebolaget SKF, Goteborg (SE)

(21) Appl. No.: 11/480,431

(22) Filed: Jul. 5, 2006

(30) Foreign Application Priority Data
Jul. 6, 2005 (SE) 0501577-1

(51) Int. Cl. F16C 13/00

(52) U.S. Cl. 384/544

(57) ABSTRACT

A motor vehicle wheel incorporates a wheel flange and a sleeve portion connected to each other. A rolling bearing has an outer race ring and an inner race ring. The sleeve portion has an axially projecting portion positioned between the wheel axle and the rolling bearing. Arranged between the bearing and the axially projecting portion are outer and inner sleeve members possessing surfaces that face one another, with the facing surfaces having ramps for increasing the external diameter of the combined inner and outer sleeve members when relatively axially displaced. During mounting, one of the inner and outer sleeve members follows axial displacement of the sleeve portion, while the other one of the inner and outer sleeve members is in contact with an axially deformable machine component that is elastically deformed during axial movement of the sleeve portion.

### TECHNOLOGICAL FIELD

The present invention generally relates to a hub and bearing arrangement. More particularly, the invention pertains to a wheel hub for a driving wheel of a motor vehicle and also to a method for mounting the wheel hub.

### BACKGROUND DISCUSSION

FIG. 1 shows a conventional design of a hub and bearing arrangement for a driving front wheel of a car, incorporating a driveshaft 1 which, via a constant velocity joint 2 (CVJ), transfers its rotational motion to a wheel axle 3. In the embodiment illustrated, the wheel axle 3 is connected via a spline joint 4 to a wheel flange 5, to which in turn a wheel rim 6 is attached by means of bolts. The wheel axle 3 and its associated components are rotatably supported in a double row angular contact ball bearing 7. In the embodiment illustrated, the one-part inner race ring of the bearing is fitted to the wheel axle 3 and clamped between a shoulder on the wheel axle and an axial portion of the wheel flange 5. The outer race ring of the bearing 7 is non-rotatably arranged in a seat in a wheel suspension 8. The double row angular contact ball bearing 7 of this conventional design according to FIG. 1 has a one-part inner ring and a one-part outer ring.

Wheel hubs for a driven wheel should be relatively easy to mount so that the hub unit and its associated rolling bearing have the correct internal clearance and preload. The wheel hub and method for mounting a wheel hub as disclosed herein allows the wheel hub to be relatively easily mounted, with the hub unit and its associated rolling bearing having the correct internal clearance and preload.

### SUMMARY

According to one aspect, a wheel hub and bearing arrangement for a wheel of a motor vehicle comprises a wheel flange and a sleeve portion connected to the wheel flange and adapted to be fixedly mounted on a wheel axle, a rolling bearing comprising an outer race ring adapted to be non-rotatably mounted in a part of a wheel suspension and an inner race ring adapted to rotate with the wheel axle, with the sleeve portion comprising an axially projecting portion of reduced diameter positionable between the wheel axle and the rolling bearing, and an outer sleeve member and an inner sleeve member arranged between the rolling bearing and the axially projecting portion of the sleeve portion. The outer and inner sleeve members possess surfaces that face one another, with the surfaces of the outer and inner sleeve members facing one another each being provided with at least one inclined ramp to increase an external diameter of the inner and outer sleeve portions when displaced axially relative each other. An axially deformable machine component is adapted to be positioned around the axle, and one of the inner and outer sleeve members is arranged during mounting to follow axial displacement of the sleeve portion, while the other one of the inner and outer sleeve members is in contact with the axially deformable machine component that is elastically deformed when the sleeve portion of the wheel flange and the bearing have reached an intended internal clearance and preload.

According to another aspect, a wheel hub and bearing arrangement mounted on a wheel axle of a motor vehicle comprises a wheel flange and a sleeve portion connected to the wheel flange, with the wheel flange and sleeve portion being mounted on the wheel axle, a rolling bearing comprising an outer race ring mounted in a part of a wheel suspension and an inner race ring, and inner and outer sleeve members. The sleeve portion comprises an axially projecting portion of reduced diameter positioned between the wheel axle and the rolling bearing, and the outer and inner sleeve members are arranged between the inner race ring of the rolling bearing and the reduced diameter portion of the sleeve portion. The outer and inner sleeve members each possess at least one inclined surface facing one another to increase a combined external dimension of the inner and outer sleeve portions when the inner and outer sleeve members are displaced axially relative each other. An axially deformable machine component is positioned around the wheel axle and possesses one portion in contact with a stop. One of the inner and outer sleeve members is adapted to be moved axially together with axial displacement of the sleeve portion, while the other one of the inner and outer sleeve members is in contact with the axially deformable machine component to deform the axially deformable machine component upon axial displacement of the sleeve portion.

According to a further aspect, a method for mounting a wheel hub to a wheel axle of a motor vehicle comprises mounting a wheel hub on a wheel axle, wherein the wheel hub comprises a wheel flange and a sleeve portion connected to the wheel flange, and the sleeve portion comprising an axially projecting reduced outer diameter portion. An outer sleeve member and an inner sleeve member are arranged between the reduced outer diameter portion of the sleeve portion and a rolling bearing that comprises an outer race ring and an inner race ring, with the outer and inner sleeve members possessing surfaces that face one another and posses at least one inclined ramp. The wheel hub is initially mounted on the wheel axle so that a space exists between the inner race ring of the bearing and a stop, while an elastically deformable machine member positioned around the wheel axle has one portion in contact with the stop. The wheel hub is axially pushed, together with the bearing and the inner and outer sleeve members, along the wheel axle to reduce the space and deform the deformable machine member.

### BRIEF DESCRIPTION OF THE DRAWING FIGURES

The features described above and additional features and aspects of the wheel hub and method disclosed here will be described below in more detail with reference to the accompanying drawing figures in which like elements are designated by like reference numerals.

FIG. 1 is a cross-sectional view of a conventional wheel hub for a driving front wheel of a car,

FIG. 2 is a cross-sectional view of a part of a wheel hub according to the present invention in a stage before final mounting.

FIG. 3 is a cross-sectional view of the wheel hub according to FIG. 2 in the mounted position.

FIG. 4 is an enlarged cross-sectional view of the wheel hub shown in FIG. 2, but with the entire hub and a portion of the wheel suspension illustrated.

### DETAILED DESCRIPTION

FIG. 2 shows in cross section a portion of a hub and bearing arrangement according as disclosed herein, in simplified form. FIG. 2 also shows a portion of a constant velocity joint (CVJ) 9 with an integral wheel axle 10. A wheel flange 11 is firmly connected to a substantially cylindrical sleeve portion 12. In the illustrated embodiment, the wheel flange 11 is formed integrally and in one piece with a substantially cylindrical sleeve portion 12.

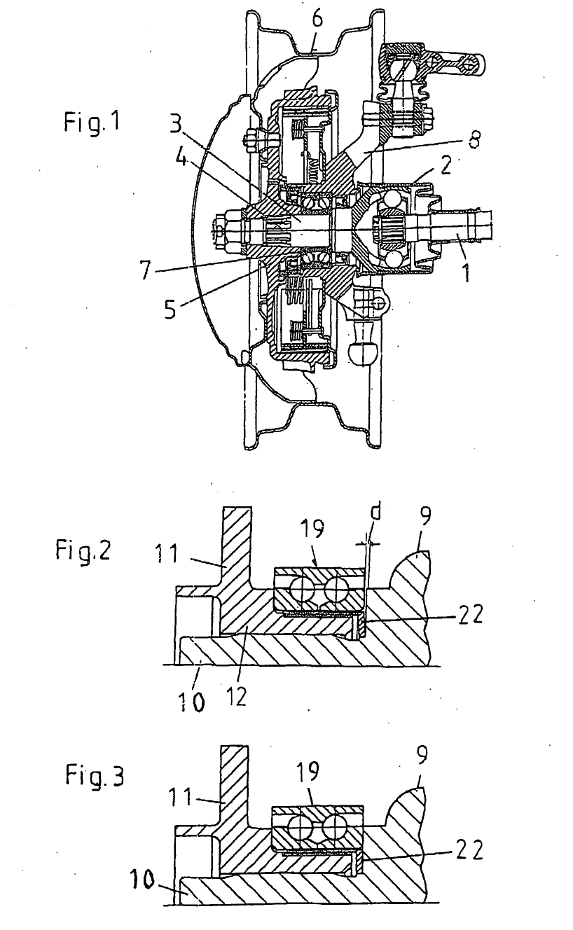

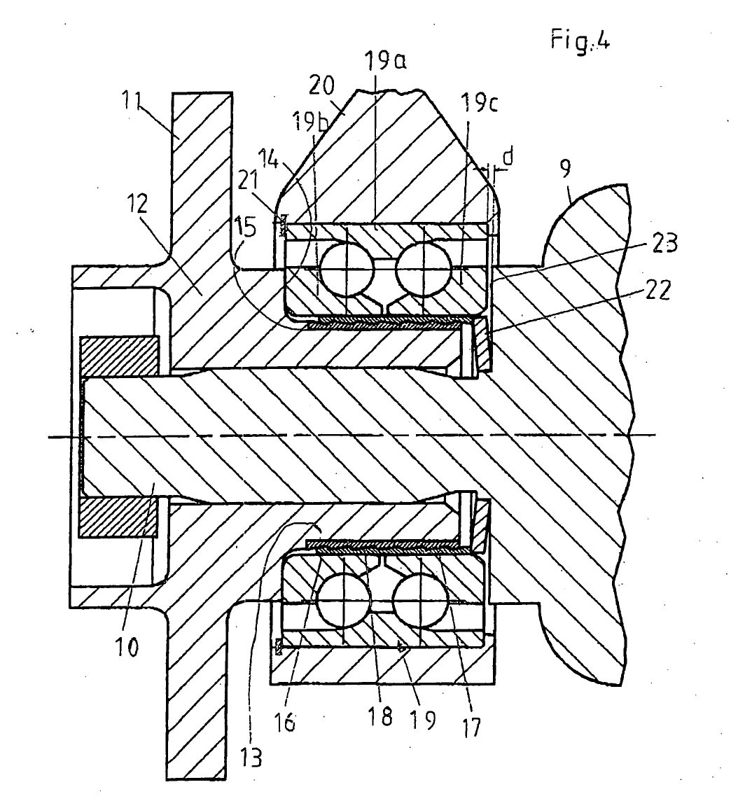

As better shown in FIG. 4, the substantially cylindrical sleeve portion 12 includes a reduced (smaller) diameter portion 13. The reduced diameter portion 13 is located at the axial end of the sleeve portion 12 facing away from the wheel flange 11. The cylindrical sleeve portion 12 also includes an axially facing (radially oriented) shoulder 14 positioned between the smaller diameter portion 13 and the rest of the cylindrical sleeve portion 12. The cylindrical sleeve portion 12 is arrested to follow the rotation of the wheel axle 10 by means of a spline joint, which can be similar to the spline joint shown in FIG. 1, or by means a key joint or the like. Adjacent the axial shoulder 14, the smaller diameter portion 13 is provided with a shallow collar 15. An inner thin-walled sleeve member 17, constituting one of a pair of thin-walled sleeve members 16, 17, is positioned on the smaller diameter portion 13 and axially engages the collar 15.

The thin-walled sleeve members 16, 17 have in their surfaces facing each other at least one inclined ramp 18. In the illustrated embodiment, the facing surfaces of the inner and outer sleeve members 16, 17 are provided with a series of tapering or inclined wave-shaped ramps 18. The thin-walled sleeve members 16, 17 are axially movable relative to each other to increase the external diametrical measure (outer dimension or outer diameter) of the two thin-walled sleeves 16, 17 when displaced in one direction relative to each other, and reduce the external diametrical measure when mutually displaced in the opposite direction. The outer peripheral surface of the outer one 16 of the two thin-walled sleeves serves as a seat for a bearing 19. The bearing 19 is constituted by a two-row angular contact ball bearing, wherein the two rows of balls have a common outer race ring and a split inner race ring rotatable with the wheel axle. Thus, the outer race ring is a one-piece race ring 19a, and the split inner race ring is comprised of two separate inner race ring portions 19b, 19c.

At the time of mounting the wheel hub on the wheel axle, the pair of sleeve members 16, 17 is mounted on the smaller diameter portion of the sleeve portion 13 as illustrated in FIGS. 2 and 4, and the bearing 19 is mounted on the sleeve members 16, 17. Upon initially mounting the wheel hub on the wheel axle 10, the bearing 19 is positioned with its two inner race ring portions 19b, 19c axially spaced apart from one another on the outer peripheral surface of the pair of sleeve members 16, 17, whereas the outer race ring 19a is pushed into a seat in a part of the wheel suspension 20 (shown in FIG. 4) so as to be non-rotatably mounted in a part of the wheel suspension. The outer race ring 19a is locked by means of a locking washer 21 or the like positioned at one end of the outer race ring.

In this position, one axial end of the inner one of the two thin-walled sleeves 17 abuts the collar 15, whereas the opposite axial end of the outer thin-walled sleeve 16 engages near the outer rim of an axially deformable machine component 22 that has been positioned on the wheel axle. In the illustrated embodiment, the axially deformable machine component is a tapering washer 22. The tapering washer 22 is arranged around the wheel axle 10 and has its inner rim in contact with a shoulder 23 on the CVJ 9. In this position illustrated in FIGS. 2 and 4, the side face of the inner race ring portion 19c, situated nearest to the shoulder 23 of the CVJ 9, is spaced apart from such shoulder a distance d, which is equal to the distance between the two inner race ring portions 19b, 19c, and which is also equal to the taper of the tapering washer 22, i.e. the axial distance between the outer rim and the inner rim of the tapering washer.

As the wheel flange 11 and the cylindrical sleeve portion 12 are axially pushed up along the wheel axle 10, i.e. to the right hand side in FIGS. 2-4, the shoulder 14 presses against one of the race ring portions 19b of the bearing 19, and at the same time the collar 15 urges the inner thin-walled sleeve 17 to move to the right, thereby causing the wave-shaped ramps 18 in the outer peripheral surface of the inner thin-walled sleeve 17 to be displaced relative the cooperating ramps 18 in the inner peripheral surface of the outer thin-walled sleeve 16. Thus, the combined radial size (outer dimension) of the pair of thin-walled sleeves 16, 17 increases, thereby increasing the grip between the smaller diameter portion 13 of the cylindrical sleeve portion 12 and the inner race ring portions 19b, 19c of the bearing 19, and also between the smaller diameter portion 13 of the cylindrical sleeve portion 12 and the wheel axle 10.

During the displacement of the wheel flange, the outer thin-walled sleeve 16 will receive a force component from its contact with the inner thin-walled sleeve 17, which results in a pressure from the outer thin-walled sleeve 16 against the outer rim of the tapering washer 22, which will then be gradually flattened out to the position shown in FIG. 3, where it is substantially planar. Here, the side face of the inner race ring portion 19c situated closest to the shoulder 23 of the CVJ 9 has come to contact against this shoulder 23, and the space between the two inner race ring portions 19b, 19c has been eliminated. This situation is shown in FIG. 3, and here the two inner race ring portions 19b, 19c are situated with their side faces opposed to each other in close contact.

Hereby, the preload on the bearing necessary for a correct operation is ascertained. In the mounted position shown in FIG. 3, the washer 22 furthermore is subjected to a tension, due to the fact that it has been subjected to a pressure flattening the originally tapering washer, and this tension can later on be utilized for possible dismounting of the wheel hub.

The principles, preferred embodiment and mounting operation have been described in the foregoing specification. However, the invention which is intended to be protected is not to be construed as limited to the particular embodiment disclosed. Further, the embodiment described herein is to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A wheel hub and bearing arrangement for a wheel of a motor vehicle comprising:
a wheel flange and a sleeve portion connected to the wheel flange and adapted to be fixedly mounted on a wheel axle;
a rolling bearing comprising an outer race ring adapted to be non-rotatably mounted in a part of a wheel suspension and an inner race ring adapted to rotate with the wheel axle;
the sleeve portion comprising an axially projecting portion of reduced diameter positionable between the wheel axle and the rolling bearing;
an outer sleeve member and an inner sleeve member arranged between the rolling bearing and the axially projecting portion of the sleeve portion;
the outer and inner sleeve members possessing surfaces that face one another, the surfaces of the outer and inner sleeve members facing one another each being provided with at least one inclined ramp to increase an external diameter of the inner and outer sleeve portions when displaced axially relative each other; and
one of the inner and outer sleeve members being arranged during mounting to follow axial displacement of the sleeve portion, while the other one of the inner and outer sleeve members is in contact with an axially deformable machine component on the wheel axle that is elastically deformed when the sleeve portion of the wheel flange and the bearing have reached an intended internal clearance and preload.

2. A wheel hub as claimed in claim 1, wherein one axial end of the inner sleeve member abuts a collar provided in the axially projecting portion of the sleeve portion so that the inner sleeve member follows axial displacement of the axially projecting portion.

3. A wheel hub as claimed in claim 2, wherein the deformable machine component is a tapering washer having an inner rim adapted to contact a fixed shoulder of the axle and an outer rim adapted to be engaged by an axial end of the outer sleeve member located farthest away from the collar.

4. A wheel hub as claimed in claim 3, wherein the tapering washer is adapted to be positioned on the axle such an axial distance between its inner and outer rims corresponds to a mounting distance required for axial displacement of the axially projecting portion at mounting.

5. A wheel hub as claimed in claim 4, wherein the outer race ring of the rolling bearing is a one-piece outer race ring, and the inner race ring is a two-part split inner race ring comprised of two inner race ring portions, wherein the two inner race ring portions are situated at an mutual distance corresponding to the axial distance between the inner and outer rims of the tapering washer.

6. A wheel hub as claimed in claim 5, wherein the bearing is a two row angular contact ball bearing with a race track for one row of balls provided in the outer race ring and in one of the inner ring portions, and a race track for another row of balls provided in the outer race ring and in the other one of the inner race ring portions.

7. A wheel hub and bearing arrangement mounted on a wheel axle of a motor vehicle comprising:
a wheel flange and a sleeve portion connected to the wheel flange, the wheel flange and sleeve portion being mounted on the wheel axle;
a rolling bearing comprising an outer race ring mounted in a part of a wheel suspension and an inner race ring;
the sleeve portion comprising an axially projecting portion of reduced diameter positioned between the wheel axle and the rolling bearing;
an outer sleeve member and an inner sleeve member arranged between the inner race ring of the rolling bearing and the reduced diameter portion of the sleeve portion, the outer and inner sleeve members each possessing at least one inclined surface facing one another to increase a combined external dimension of the inner and outer sleeve portions when the inner and outer sleeve members are displaced axially relative each other;
an axially deformable machine component positioned around the wheel axle and possessing one portion in contact with a stop;
one of the inner and outer sleeve members being moved axially together with axial displacement of the sleeve portion, while the other one of the inner and outer sleeve members is in contact with the axially deformable machine component to deform the axially deformable machine component upon axial displacement of the sleeve portion.

8. A wheel hub as claimed in claim 7, wherein the stop is a shoulder of the wheel axle.

9. A wheel hub as claimed in claim 7, wherein one axial end of the inner sleeve member abuts a collar provided in the reduced diameter portion of the sleeve portion so that the inner sleeve member follows axial displacement of the sleeve portion.

10. A wheel hub as claimed in claim 7, wherein the deformable machine component is a tapering washer having an inner rim constituting the one portion in contact with the stop, the tapering washer also possessing an outer rim in contact with an axial end of the outer sleeve member.

11. A wheel hub as claimed in claim 10, wherein the tapering washer is positioned on the wheel axle such an axial distance between the inner and outer rims of the tapering washer corresponds to an axial distance that the sleeve portion is axially displaced.

12. A wheel hub as claimed in claim 11, wherein the outer race ring of the rolling bearing is a one-piece outer race ring, and the inner race ring is a two-part split inner race ring comprised of two inner race ring portions, wherein the two inner race ring portions are spaced apart by a distance that is the same as the axial distance between the inner and outer rims of the tapering washer.

13. A method for mounting a wheel hub to a wheel axle of a motor vehicle comprising:
mounting a wheel hub on a wheel axle, the wheel hub comprising a wheel flange and a sleeve portion connected to the wheel flange, the sleeve portion comprising an axially projecting reduced outer diameter portion, with an outer sleeve member and an inner sleeve member arranged between the reduced outer diameter portion of the sleeve portion and a rolling bearing that comprises an outer race ring and an inner race ring, the outer and inner sleeve members possessing surfaces that face one another, with the surfaces of the outer and inner sleeve members facing one another being provided with at least one inclined ramp;
the wheel hub being initially mounted on the wheel axle so that a space exists between the inner race ring of the bearing and a stop, while an elastically deformable machine member positioned around the wheel axle has one portion in contact with the stop; and
axially pushing the wheel hub, together with the bearing and the inner and outer sleeve members, along the wheel axle to reduce the space and deform the deformable machine member.

14. The method according to claim 13, wherein the inner race ring comprises two separate inner race ring portions that are spaced apart from one another by a distance when the wheel hub is mounted on the wheel axle, the distance between the inner race ring portions being reduced as the wheel hub is axially pushed along the wheel axle to deform the deformable machine member.

15. The method according to claim 13, wherein the inner race ring comprises two separate inner race ring portions that are spaced apart from one another by a distance when the wheel hub is mounted on the wheel axle, the two inner race ring portions being brought into contact with one another as the wheel hub is axially pushed along the wheel axle to deform the deformable machine member.

16. The method according to claim 13, wherein the inner sleeve member engages a collar provided in the reduced outer diameter portion of the sleeve portion, and the outer sleeve member engages an outer portion of the deformable machine member when the wheel hub is mounted on the wheel axle, the inner and outer sleeve members together possessing a combined outer dimension, wherein when the wheel hub is axially pushed along the wheel axle the collar urges the inner sleeve member to move toward the stop to cause the wave-shaped ramps of the inner sleeve member to be axially displaced relative to the wave-shaped ramps of the outer sleeve member to increase the combined outer dimension of the inner and outer sleeve members and increase a gripping force between the reduced outer diameter portion of the sleeve portion and the inner race ring of the bearing.

17. The method according to claim 13, comprising positioning the outer race ring of the bearing in a seat of a wheel suspension.

18. The method according to claim 13, wherein an end face of the inner race ring of the bearing is spaced apart from the stop when the wheel hub is mounted on the wheel axle, the end face of the inner race ring being brought into contact with the stop when the wheel hub is axially pushed along the wheel axle.
